(19) United States
(12) Patent Application Publication
(10) Pub. No.: US 2024/0320541 A1
(43) Pub. Date: Sep. 26, 2024

(54) MACHINE LEARNING MODEL RISK ASSESSMENT USING SHADOW MODELS

(71) Applicant: International Business Machines Corporation, Armonk, NY (US)

(72) Inventors: Abigail Goldsteen, Haifa (IL); Shlomit Ifergan Shachor, Yokneam Eilit (IL); Natalia Razinkov, Haifa (IL)

(73) Assignee: International Business Machines Corporation, Armonk, NY (US)

(21) Appl. No.: 18/125,830

(22) Filed: Mar. 24, 2023

(51) Int. Cl. G06N 20/00

(52) U.S. Cl. CPC G06N 20/00

(57) ABSTRACT

Using data of a target machine learning model, a shadow model is generated. A predefined test is performed on the shadow model, the performing resulting in a first test result. A risk score comprising the first test result and a second test result is computed, the second test result obtained by performing a second predefined test using the data of the target machine learning model.

### BACKGROUND

The present invention relates generally to a method, system, and computer program product for machine learning model risk assessment. More particularly, the present invention relates to a method, system, and computer program product for machine learning model risk assessment using shadow models.

A machine learning model is a model built based on sample data, known as training data, in order to make predictions or decisions without being explicitly programmed to do so. In general, a learning problem considers a set of n samples of data and then tries to predict properties of unknown data. If each sample is more than a single number (e.g., a multi-dimensional number) the sample is said to have several attributes or features. Some models also output a probability or confidence value associated with a predicted property. One type of machine learning is supervised learning, in which the data comes with additional attributes (i.e., labels) that the model is intended to predict. Within supervised learning, in classification the samples belong to two or more classes and the model learns to predict the class of unlabeled data from already labeled data. For example, an image classifier might learn from labeled images of different types of animals to predict the type of animal depicted in a new image. Within supervised learning, in regression the desired output consists of one or more continuous variables. Another type of machine learning is unsupervised learning, in which the data does not come with additional attributes, and instead the model discovers groups of similar examples within the data, to determine the distribution of data within the input space, or performs other data analysis tasks. Typically, a model is trained using training data, and tested using testing data to determine if the model is sufficiently trained for an intended use. Often, training data and testing data are simply two subsets of the same set of sample data.

Some examples of machine learning models are the models generated by Scikit-learn, an open-source machine learning library that supports supervised and unsupervised learning, including tools for model fitting, data preprocessing, model selection, model evaluation, and the like. Within the scikit-learn library, DecisionTreeClassifier is a class capable of performing multi-class classification on a dataset, a GradientBoostingClassifier class implements classification using gradient boosted decision trees, and a GradientBoostingRegressor class implements regression using gradient boosted decision trees. Gradient boosting is a machine learning technique that produces a prediction model in the form of an ensemble of weak prediction models, which are typically decision trees.

Machine learning models are subject to attacks that are able to infer, from a trained model, information intended to be kept private. For example, in a membership inference attack, given a trained model and a data sample, one can deduce whether or not that sample was part of the model's training. As another example, in an attribute inference attack, certain features may be inferred about individuals who participated in training a model. Given a trained model and knowledge about some of the features of a specific person, it may be possible to deduce the value of additional, unknown features of that person-including features the person may not wish to disclose. As another example, a model inversion attack aims to reconstruct representative feature values of the training data by inverting a trained model. For example, it may be possible to reconstruct an average sample for a given class. If a class represents a certain person or group of people, such as in facial recognition models, a model inversion attack may also result in disclosing protected data to an unauthorized party. As another example, an attribute inference based on membership inference attack finds the target feature value that causes the membership inference attack to classify, with the highest confidence, the sample as a member. A white-box attack assumes an attacker has access to the internals of a model, including the model's architecture, parameters and weights, e.g., when the model itself has been published or shared. A black-box attack assumes an attacker does not have access to a model's internals, but is able to query the model to get predicted outputs (e.g., a value or class) for a given input, which is typically the case when a model has been deployed for use as a service. For example, a machine learning as a service implementation typically provides an application programming interface for uploading data and for training and querying models, but details of the models and their training algorithms are hidden from data owners using the models. In addition, the service provider typically selects the model type, and models cannot be downloaded and used separately from the service.

A shadow model, or surrogate model, imitates the behavior of a target machine learning model. A shadow model has similar characteristics to the target model being imitated. However, an adversary (or tester) has control over which data is used to train the shadow model and thus the ground truth about membership in these datasets.

The illustrative embodiments recognize that machine learning models are often subjected to specific tests, including membership inference attacks, attribute inference attacks, and model inversion attacks, as part of a risk assessment process assessing an attacker's ability to extract information from a model. However, in order to run an attack and evaluate an attack's success rate, required data is often unavailable or subject to usage restrictions. In some situations, an already-trained model might not be available for testing, the model's training or testing data might not be available, or data use restrictions might preclude risking extracting data from a model in the course of performing test attacks. For example, a membership inference attack in black box mode currently requires the model's predictions on its training data and on test data. As another example, an attribute inference based on membership inference attack currently requires both training and test data, as well as query access to the model itself. Thus, the illustrative embodiments recognize that there is a need to improve machine learning model risk assessment by performing test attacks even when some model-related data is unavailable for testing use.

### SUMMARY

The illustrative embodiments provide a method, system, and computer program product. An embodiment includes a method that generates, using data of a target machine learning model, a shadow model. An embodiment performs a predefined test on the shadow model, the performing resulting in a first test result. An embodiment computes a risk score comprising the first test result and a second test result, the second test result obtained by performing a second predefined test using the data of the target machine learning model.

In another embodiment, the shadow model is generated responsive to determining that the data of the target machine learning model is insufficient to perform the test on the target machine learning model. Thus, the embodiment provides additional detail of a condition responsive to which the shadow model is generated.

Another embodiment further comprises generating, using a plurality of frameworks, a corresponding plurality of shadow models; and selecting, from the corresponding plurality of shadow models using a similarity metric, the shadow model, wherein the similarity metric measures a similarity between a plurality of outputs of the shadow model and a plurality of outputs of the target machine-learning model. Thus, the embodiment provides a particular manner of selecting a shadow model.

In another embodiment, the shadow model is generated using a framework specified by the data of the target machine learning model. Thus, the embodiment provides a particular manner of generating a shadow model.

In another embodiment, the shadow model is trained using training data of the target machine learning model. Thus, the embodiment provides a particular manner of training a shadow model.

In another embodiment, the shadow model is trained using test data of the target machine learning model. Thus, the embodiment provides a particular manner of training a shadow model.

In another embodiment, the risk score comprises a weighted average including the first test result and the second test result, and a weight in the weighted average is set according to a model on which the predefined test was performed. Thus, the embodiment provides a particular manner of computing the risk score.

In another embodiment, the risk score comprises a weighted average including the first test result and the second test result, and a weight in the weighted average is set according to a type of data used to perform the predefined test. Thus, the embodiment provides a particular manner of computing the risk score.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for machine learning model risk assessment using shadow models in accordance with an illustrative embodiment;

FIG. 3 depicts a flow diagram of machine learning model risk assessment using shadow models in accordance with an illustrative embodiment;

FIG. 4 depicts a flowchart of an example process for machine learning model risk assessment using shadow models in accordance with an illustrative embodiment.

### DETAILED DESCRIPTION

The illustrative embodiments recognize that there is a need to improve machine learning model risk assessment by performing test attacks even when some model-related data is unavailable for testing use.

The illustrative embodiments recognize that the presently available tools or solutions do not address these needs or provide adequate solutions for these needs. The illustrative embodiments used to describe the invention generally address and solve the above-described problems and other problems related to machine learning model risk assessment using shadow models.

An embodiment can be implemented as a software application. The application implementing an embodiment can be configured as a modification of an existing machine learning model risk assessment system, as a separate application that operates in conjunction with an existing machine learning model risk assessment system, a standalone application, or some combination thereof.

Particularly, some illustrative embodiments provide a method that uses data of a target machine learning model to generate a shadow model, performs a predefined test on the shadow model generating a first test result, and computes a risk score aggregating test results.

An embodiment receives information about a target model for which risk assessment is to be performed. The information includes one or more of the following details needed to access a trained machine learning model (e.g., location, login information required, application program interface (API) enabling an embodiment to use a model implemented as machine-learning-as-a-service and to generate model predictions), a trained or untrained machine learning model object, a specified model type (e.g., DecisionTreeClassifier in the scikit-learn library), a specified model framework (e.g., the scikit-learn library), and an output type of the model (e.g., regressor or classifier probabilities or labels). An embodiment, optionally, receives input data to the target model, such as training or testing data. An embodiment, optionally, receives output data from the target model, such as the model's predictions on training or testing data. One embodiment also receives a list or other specification of one or more predefined tests, with test execution requirements, to be performed on the target model using the data available. In another embodiment, a list or other specification of one or more predefined tests, with test execution requirements, to be performed on the target model using the data available is predefined and stored internally to an embodiment, and not received as input. Some non-limiting examples of test execution requirements include a specification that a particular test is mandatory or optional, conditions under which a target model or shadow model should be used to perform a particular test, the data or type of data to be used when performing a particular test, a minimum or maximum number of times a particular test should be performed, and the like.

An embodiment uses the test execution requirements for one of the predefined tests to determine whether a particular test can be performed on the target model using the data available. If a particular test can be performed on the target model, an embodiment performs the test on the target model.

If the test cannot be performed on the target model using the data available, an embodiment uses a presently available technique to generate a shadow model corresponding to the target model. For example, given a model framework and type (e.g., the target model is a decision tree classifier produced using the scikit-learn library), an embodiment uses the specified framework to generate the same type of model. As another example, given a model prediction or model training data, and a model framework, an embodiment if necessary uses the model prediction to determine an output type the model should produce (e.g., whether the model should be a classifier or regression model), and uses the specified framework to generate a corresponding type of model. As another example, given a specification of the type of the target model (e.g., the target model is a decision tree classifier model), an embodiment selects a model framework and uses the selected framework to generate a shadow model of the same type (e.g., the shadow model is also a decision tree classifier model). As another example, given a model prediction or model training data, an embodiment uses the model prediction or training data to determine an output type the model should produce (e.g., whether the model should be a classifier or regression model), selects a model framework usable to implement that type of model, and uses the selected framework to generate a shadow model of the same type (e.g., the shadow model is also a classifier model). In particular, if training data for the target model is available, an embodiment uses the training data to generate a shadow model corresponding to the target model. If training data for the target model is not available, but test data for the target model is available, an embodiment uses the test data to generate a shadow model corresponding to the target model. One embodiment generates multiple shadow models, and uses a presently available model similarity metric (e.g., R-squared for a regression model, or a classification error rate for a classifier model) to select the shadow model producing outputs most similar to those of the target model. Another embodiment generates multiple shadow models of different types within a model framework (e.g., Decision Tree Classifier, Random Forrest Classifier), and uses a presently available model similarity metric to select the shadow model producing outputs most similar to those of the target model. An embodiment performs the test on a shadow model. Another embodiment generates multiple shadow models of the same type, and merges (e.g., by averaging) results from using multiple shadow datasets. If there is insufficient data to generate a shadow model on which to perform the test or the generated shadow model is not sufficiently similar (based on the similarity metric) to the target model, an embodiment records the test as not performed. If there are additional tests to be performed, an embodiment repeats the determining and model generation, if necessary, and if possible, performs an additional test on either the target or a shadow model. One embodiment uses a two-stage process, in which an embodiment generates a test plan specifying model(s) to be generated, test(s) to be performed and data on which to perform the test(s), then generates the specified model(s) and performs the specified test(s) using the specified data according to the test plan.

Consider an example use case in which an embodiment receives information about a target model for which risk assessment is to be performed. The information includes a specification of a target model framework (e.g., the Scikit-learn library), but not the target model itself. The information also includes labeled training and test data and predictions output by the target model on the training and test data. Some of the predefined tests cannot be performed using the available data, thus an embodiment generates a plan specifying that a shadow model is to be generated, that a membership inference test is to be run in a black box mode using the target model's predictions, an attribute inference test is to be run in a black box mode using the target model's predictions, an attribute inference based on membership inference test is to be run in a black box mode on the shadow model using the received model training data, and that an attribute inference baseline test is to be run using both the target model's predictions and on the shadow model using the received model training data. An embodiment uses the model prediction data to determine an output type the model should produce (if necessary), and uses the specified framework to generate a corresponding type of shadow model. An embodiment performs the specified test(s) using the specified data. Thus, using the shadow model enables an embodiment to perform an attribute inference based on membership inference test in a black box mode.

Consider a second example use case in which an embodiment receives information about a target model for which risk assessment is to be performed. The information includes a specification of a target model type and framework (e.g., a scikit-learn model that learns using gradient boosting), but not the target model itself. The information also includes labeled training data used by the target model and predictions output by the target model on the training data. Some of the predefined tests cannot be performed using the available data, thus an embodiment generates a plan specifying that a shadow model is to be generated, that a membership inference test is to be run in a black box mode using the shadow model (trained using the training data), an attribute inference test is to be run in a black box mode using the predictions on the training data, an attribute inference based on membership inference test is to be run in a black box mode on the shadow model using the training data, and that an attribute inference baseline test is to be run using both the target model's predictions on the training data and on the shadow model (trained using the training data). An embodiment generates a shadow model of the specified type, using the specified framework. An embodiment performs the specified test(s) using the specified data. Thus, using the shadow model enables an embodiment to perform a membership inference test and an attribute inference based on membership inference test using the available data.

Consider a third example use case in which an embodiment receives information about a target model for which risk assessment is to be performed. The information includes a specification of a target model type and framework (e.g., a scikit-learn decision tree model), but not the target model itself. The information also includes labeled test data and predictions output by the target model on the test data. Some of the predefined tests cannot be performed using the available data, thus an embodiment generates a plan specifying that a shadow model is to be generated, that a membership inference test is to be run in a black box mode using the shadow model (trained using the test data), an attribute inference test is to be run in a black box mode using the shadow model (trained using the test data), an attribute inference based on membership inference test is to be run in a black box mode on the shadow model using the test data, and that an attribute inference baseline test is to be run on the shadow model (trained using the test data). An embodiment uses the selected framework to generate a shadow model of the specified type. An embodiment performs the specified test(s) using the specified data. Thus, using the shadow model enables an embodiment to perform tests using the available test data.

Consider a fourth example use case in which an embodiment receives information about a target model for which risk assessment is to be performed. The information includes a trained target model and training data used by the target model. Some of the predefined tests cannot be performed using the available data, thus an embodiment generates a plan specifying that a shadow model is to be generated, that a membership inference test is to be run in a black box mode using the shadow model (trained using the training data), an attribute inference test is to be run in a black box mode using the target model, an attribute inference based on membership inference test is to be run in a black box mode on the shadow model using the training data, and that an attribute inference baseline test is to be run on the target model and the shadow model (trained using the training data). An embodiment generates a shadow model corresponding to the trained target model, and performs the specified test(s) using the specified data. Thus, using the shadow model enables an embodiment to perform a membership inference test and an attribute inference based on membership inference test using the available training data.

Consider a fifth example use case in which an embodiment receives information about a target model for which risk assessment is to be performed. The information does not include a framework or target model type, but does include training or test data of the model. Some of the predefined tests cannot be performed using the available data, thus an embodiment generates a plan specifying that several shadow models of often-used model types and often-used model frameworks are to be generated and a shadow model selected using the similarity metric. The plan also specifies that all of the tests are to be run on the selected shadow model.

Some non-limiting examples of test results are attack accuracy, precision, recall, F1 score, and AUC-ROC. Accuracy is the number of correct predictions over the overall predictions, precision is the rate of true positives over all predicted positives, recall is the rate of true positives over all actual positives, the F1 score is the harmonic mean of the precision and the recall, and the area under the Receiver Operating Characteristic Curve (ROC AUC) is determined from prediction scores.

One embodiment performs multiple iterations of a test and combines the results together, for example by averaging the results of the same type together (e.g., all the accuracy results).

An embodiment uses the test results to compute a risk score for the target model. One embodiment normalizes test results onto the same scale (e.g., 0 to 1), and uses a weighted average of the normalized results as the risk score. In one embodiment, weights used in the weighted average have predefined values, based on a type of test. For example, one embodiment might weight results of a membership inference attack more highly than results of an attribute interference attack. In another embodiment, weights used in the weighted average have predefined values, based on whether a target or shadow model was used to perform that test. For example, an embodiment might weight results obtained using a target model higher than results obtained using a shadow model. In another embodiment, weights used in the weighted average have predefined values, based on the type of data used to perform that test. For example, an embodiment might weight model results obtained using training data higher than model results obtained using testing data. In another embodiment, weights used in the weighted average have predefined values, based on the similarity between the target and shadow models used to perform that test.

If a risk score for a target model is below a threshold value, the target model is considered to have an acceptable risk level, and thus an embodiment deploys the target model for use on new (runtime) data. One embodiment deploys a target model once a user has had an opportunity to evaluate the risk score and opt to deploy the model. Another embodiment causes another application to deploy a target model.

The manner of machine learning model risk assessment using shadow models described herein is unavailable in the presently available methods in the technological field of endeavor pertaining to machine learning model risk assessment. A method of an embodiment described herein, when implemented to execute on a device or data processing system, comprises substantial advancement of the functionality of that device or data processing system in using data of a target machine learning model to generate a shadow model, performing a predefined test on the shadow model generating a first test result, and computing a risk score aggregating test results.

The illustrative embodiments are described with respect to certain types of tests, attacks, target models, shadow models, training data, test data, predictions, test results, weights, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

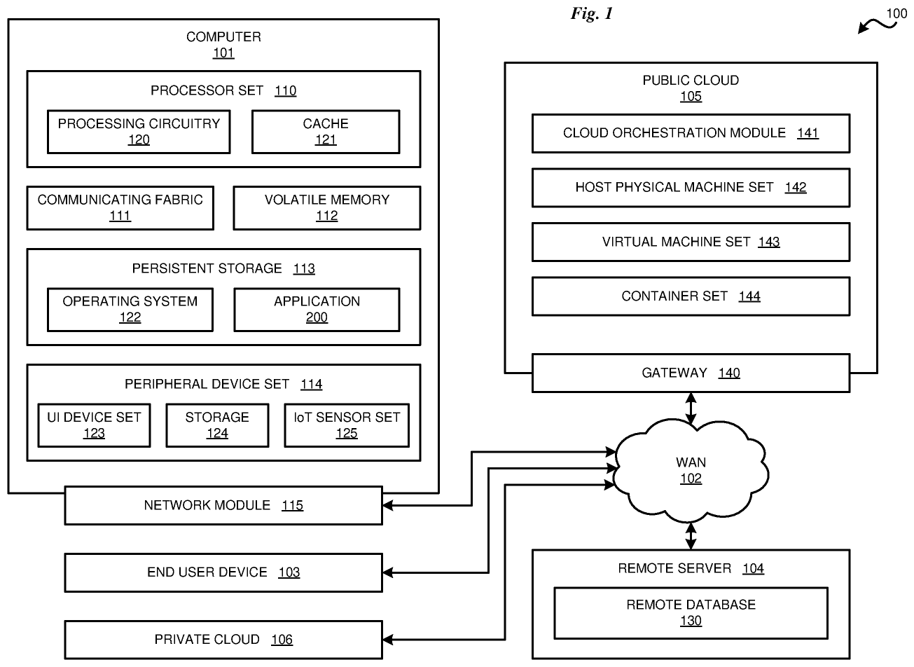

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements a machine learning model risk assessment using shadow models embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way. EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

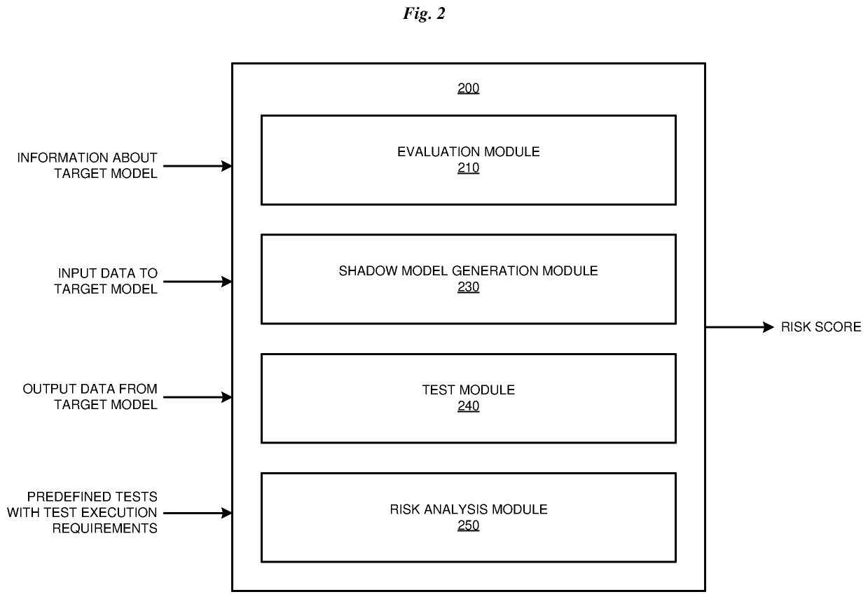

With reference to FIG. 2, this figure depicts a block diagram of an example configuration for machine learning model risk assessment using shadow models in accordance with an illustrative embodiment. Application 200 is the same as application 200 in FIG. 1.

Evaluation module 210 receives information about a target model for which risk assessment is to be performed. The information includes one or more of the following details needed to access a trained machine learning model (e.g., location, login information required, application program interface (API) enabling an embodiment to use a model implemented as machine-learning-as-a-service and to generate model predictions), a trained or untrained machine learning model object, a specified model type (e.g., DecisionTreeClassifier in the scikit-learn library), a specified model framework (e.g., the scikit-learn library), and an output type of the model output type (e.g., regressor or classifier probabilities or labels). Module 210, optionally, receives input data to the target model, such as training or testing data. Module 210, optionally, receives output data from the target model, such as the model's predictions on training or testing data. One implementation of module 210 also receives a list or other specification of one or more predefined tests, with test execution requirements, to be performed on the target model using the data available. In another implementation of module 210, a list or other specification of one or more predefined tests, with test execution requirements, to be performed on the target model using the data available is predefined and stored internally to an embodiment, and not received as input. Some non-limiting examples of test execution requirements include a specification that a particular test is mandatory or optional, conditions under which a target model or shadow model should be used to perform a particular test, the data or type of data to be used when performing a particular test, a minimum or maximum number of times a particular test should be performed, and the like.

Module 210 uses the test execution requirements for one of the predefined tests to determine whether a particular test can be performed on the target model using the data available. If a particular test can be performed on the target model, test module 240 performs the test on the target model.

If the test cannot be performed on the target model using the data available, shadow model generation module 230 uses a presently available technique to generate a shadow model corresponding to the target model. For example, given a model framework and type (e.g., the target model is a decision tree classifier produced using the scikit-learn library), module 230 uses the specified framework to generate the same type of model. As another example, given a model prediction or model training data, and a model framework, evaluation module 210 if necessary uses the model prediction to determine an output type the model should produce (e.g., whether the model should be a classifier or regression model), and module 230 uses the specified framework to generate a corresponding type of model. As another example, given a specification of the type of the target model (e.g., the target model is a decision tree classifier model), module 230 selects a model framework and uses the selected framework to generate a shadow model of the same type (e.g., the shadow model is also a decision tree classifier model). As another example, given a model prediction or model training data, module 210 uses the model prediction or training data to determine an output type the model should produce (e.g., whether the model should be a classifier or regression model), and module 230 selects a model framework usable to implement that type of model and uses the selected framework to generate a shadow model of the same type (e.g., the shadow model is also a classifier model). In particular, if training data for the target model is available, module 230 uses the training data to generate a shadow model corresponding to the target model. If training data for the target model is not available, but test data for the target model is available, module 230 uses the test data to generate a shadow model corresponding to the target model. One implementation of module 230 generates multiple shadow models, and uses a presently available model similarity metric (e.g., R-squared for a regression model, or a classification error rate for a classifier model) to select the shadow model producing outputs most similar to those of the target model. Another implementation of module 230 generates multiple shadow models of different types within a model framework (e.g., Decision Tree Classifier, Random Forrest Classifier), and uses a presently available model similarity metric to select the shadow model producing outputs most similar to those of the target model. Another implementation of module 230 generates multiple shadow models of the same type., and merges (e.g., by averaging) results from using multiple shadow datasets. Test module 240 performs the test on one or more shadow models, and if necessary merges (e.g., by averaging) results from using multiple shadow datasets. If there is insufficient data to generate a shadow model on which to perform the test or the generated shadow model is not sufficiently similar (based on the similarity metric) to the target model, application 200 records the test as not performed. If there are additional tests to be performed, application 200 repeats the determining and model generation, if necessary, and if possible performs an additional test on either the target or a shadow model. One implementation of application 200 uses a two-stage process, in which module 210 generates a test plan specifying model(s) to be generated, test(s) to be performed and data on which to perform the test(s), module 230 generates the specified shadow model(s), and module 240 performs the specified test(s) using the specified data according to the test plan.

One implementation of module 240 performs multiple iterations of a test, and combines the results together, for example by averaging the results of the same type together (e.g., all the accuracy results).

Risk analysis module 250 uses the test results to compute a risk score for the target model. One implementation of module 250 normalizes test results onto the same scale (e.g., 0 to 1), and uses a weighted average of the normalized results as the risk score. In one implementation of module 250, weights used in the weighted average have predefined values, based on a type of test. For example, one implementation of module 250 might weight results of a membership inference attack more highly than results of an attribute interference attack. In another implementation of module 250, weights used in the weighted average have predefined values, based on whether a target or shadow model was used to perform that test. For example, an implementation of module 250 might weight results obtained using a target model higher than results obtained using a shadow model. In another implementation of module 250, weights used in the weighted average have predefined values, based on the type of data used to perform that test. For example, an implementation of module 250 might weight model results obtained using training data higher than model results obtained using testing data. In another implementation of module 250, weights used in the weighted average have predefined values, based on the similarity between the target and shadow models used to perform that test.

If a risk score for a target model is below a threshold value, the target model is considered to have an acceptable risk level, and thus application 200 deploys the target model for use on new (runtime) data. One implementation of application 200 deploys a target model once a user has had an opportunity to evaluate the risk score and opt to deploy the model. Another implementation of application 200 causes another application to deploy a target model.

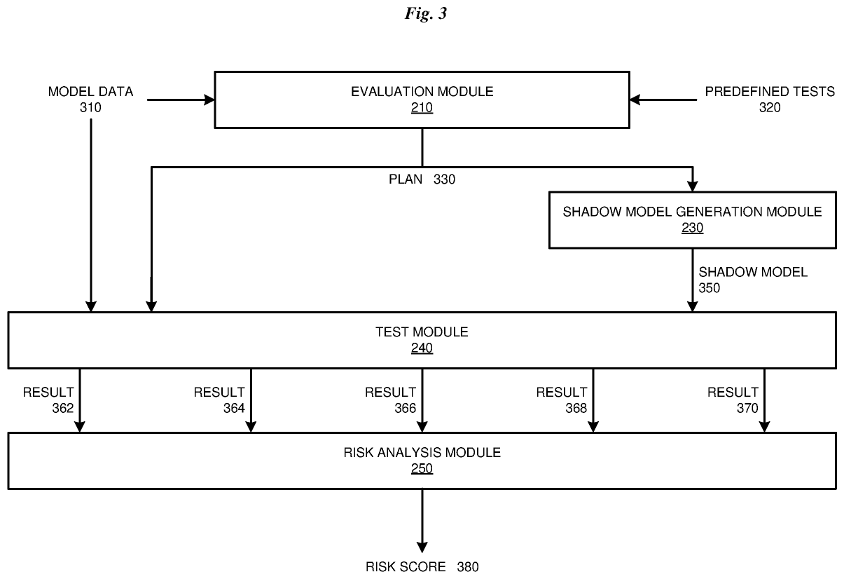

With reference to FIG. 3, this figure depicts a flow diagram of machine learning model risk assessment using shadow models in accordance with an illustrative embodiment. Evaluation module 210, shadow module 230, test module 240, and risk analysis module 250 are the same as evaluation module 210, shadow module 230, test module 240, and risk analysis module 250 in FIG. 2. The example can be executed using application 200 in FIG. 2.

Evaluation module 210 receives model data 310, information about a target model for which risk assessment is to be performed. Evaluation module 210 also receives predefined tests 320, along with test execution requirements, to be performed on the target model using model data 310.

Module 210 generates plan 330, which specifies that a shadow model is to be generated, and specifies the tests to be run on model data 310 and the generated shadow model Shadow model generation module 230 generates shadow model 350. Test module 240 executes tests 320 according to plan 330, producing results 362, 364, 366, 368, and 370. Risk analysis module 250 combines results 362, 364, 366, 368, and 370 into risk score 380.

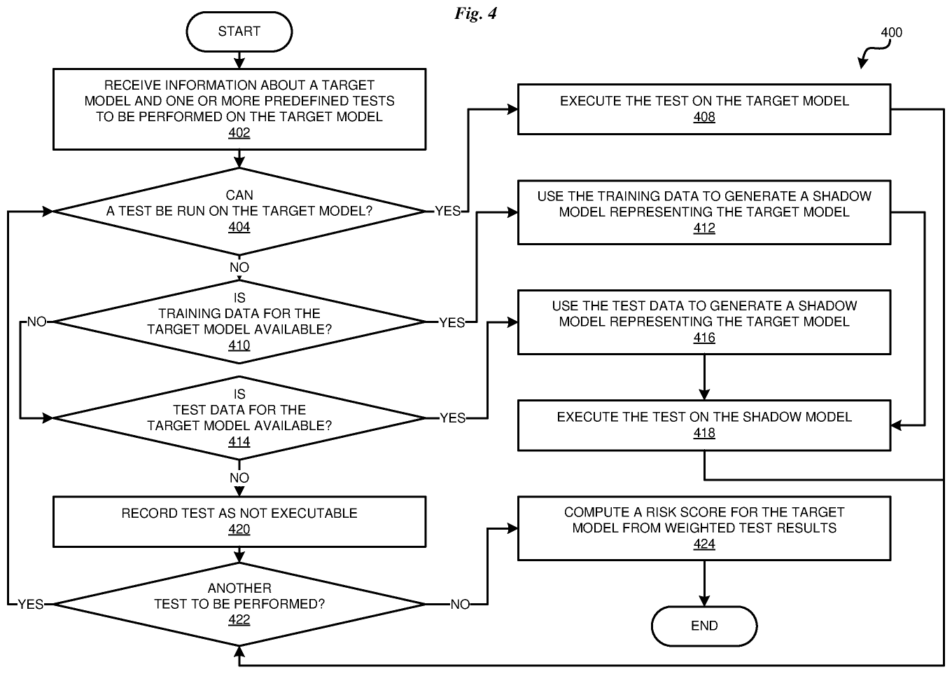

With reference to FIG. 4, this figure depicts a flowchart of an example process for machine learning model risk assessment using shadow models in accordance with an illustrative embodiment. Process 400 can be implemented in application 200 in FIG. 2.

In block 402, the application receives Information about a target model and one or more predefined tests to be performed on the target model. In block 404, the application determines whether a test can be run on the target model. If yes (“YES” path of block 404, in block 408 the application executes the test on the target model or using the target model's data and proceeds to block 422. Otherwise (“NO” path of block 704), in block 410 the application determines whether training data for the target model is available. If yes (“YES” path of block 410, in block 412 the application uses the training data to generate a shadow model representing the target model, and proceeds to block 418. Otherwise (“NO” path of block 410), in block 414 the application determines whether test data for the target model available. If yes (“YES” path of block 414, in block 416 the application uses the test data to generate a shadow model representing the target model. In block 418, the application executes the test on the shadow model. Otherwise (“NO” path of block 414), in block 420 the application records the test as not executable. In block 422, the application determines whether another test is to be performed. If yes (“YES” path of block 422) the application returns to block 404. Otherwise (“NO” path of block 422), in block 424 the application computes a risk score for the target model from weighted test results. Then the application ends.

Thus, a computer implemented method, system or apparatus, and computer program product are provided in the illustrative embodiments for machine learning model risk assessment using shadow models and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

What is claimed is:

1. A computer-implemented method comprising:
generating, using data of a target machine learning model, a shadow model;
performing a predefined test on the shadow model, the performing resulting in a first test result; and
computing a risk score comprising the first test result and a second test result, the second test result obtained by performing a second predefined test using the data of the target machine learning model.

2. The computer-implemented method of claim 1, wherein the shadow model is generated responsive to determining that the data of the target machine learning model is insufficient to perform the test on the target machine learning model.

3. The computer-implemented method of claim 1, further comprising:
generating, using a plurality of frameworks, a corresponding plurality of shadow models; and
selecting, from the corresponding plurality of shadow models using a similarity metric, the shadow model, wherein the similarity metric measures a similarity between a plurality of outputs of the shadow model and a plurality of outputs of the target machine-learning model.

4. The computer-implemented method of claim 1, wherein the shadow model is generated using a framework specified by the data of the target machine learning model.

5. The computer-implemented method of claim 1, wherein the shadow model is trained using training data of the target machine learning model.

6. The computer-implemented method of claim 1, wherein the shadow model is trained using test data of the target machine learning model.

7. The computer-implemented method of claim 1, wherein the risk score comprises a weighted average including the first test result and the second test result, wherein a weight in the weighted average is set according to a model on which the predefined test was performed.

8. The computer-implemented method of claim 1, wherein the risk score comprises a weighted average including the first test result and the second test result wherein a weight in the weighted average is set according to a type of data used to perform the predefined test.

9. A computer program product comprising one or more computer readable storage medium, and program instructions collectively stored on the one or more computer readable storage medium, the program instructions executable by a processor to cause the processor to perform operations comprising:
generating, using data of a target machine learning model, a shadow model;
performing a predefined test on the shadow model, the performing resulting in a first test result; and
computing a risk score comprising the first test result and a second test result, the second test result obtained by performing a second predefined test using the data of the target machine learning model.

10. The computer program product of claim 9, wherein the stored program instructions are stored in a computer readable storage device in a data processing system, and wherein the stored program instructions are transferred over a network from a remote data processing system.

11. The computer program product of claim 9, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

12. The computer program product of claim 9, wherein the shadow model is generated responsive to determining that the data of the target machine learning model is insufficient to perform the test on the target machine learning model.

13. The computer program product of claim 9, further comprising:
generating, using a plurality of frameworks, a corresponding plurality of shadow models; and
selecting, from the corresponding plurality of shadow models using a similarity metric, the shadow model, wherein the similarity metric measures a similarity between a plurality of outputs of the shadow model and a plurality of outputs of the target machine-learning model.

14. The computer program product of claim 9, wherein the shadow model is generated using a framework specified by the data of the target machine learning model.

15. The computer program product of claim 9, wherein the shadow model is trained using training data of the target machine learning model.

16. The computer program product of claim 9, wherein the shadow model is trained using test data of the target machine learning model.

17. The computer program product of claim 9, wherein the risk score comprises a weighted average including the first test result and the second test result, wherein a weight in the weighted average is set according to a model on which the predefined test was performed.

18. The computer program product of claim 9, wherein the risk score comprises a weighted average including the first test result and the second test result, wherein a weight in the weighted average is set according to a type of data used to perform the predefined test.

19. A computer system comprising a processor and one or more computer readable storage media, and program instructions collectively stored on the one or more computer readable storage media, the program instructions executable by the processor to cause the processor to perform operations comprising:
generating, using data of a target machine learning model, a shadow model;
performing a predefined test on the shadow model, the performing resulting in a first test result; and
computing a risk score comprising the first test result and a second test result, the second test result obtained by performing a second predefined test using the data of the target machine learning model.

20. The computer system of claim 19, wherein the shadow model is generated responsive to determining that the data of the target machine learning model is insufficient to perform the test on the target machine learning model.
